(19) United States
(12) Patent Application Publication
(10) Pub. No.: US 2026/0087255 A1
(43) Pub. Date: Mar. 26, 2026

(54) METHOD FOR AUTOMATED NATURAL-LANGUAGE TEXT PROCESSING

(71) Applicant: Artem Aleksandrovich KRAVCHENKO, Moscow (RU)

(72) Inventor: Artem Aleksandrovich KRAVCHENKO, Moscow (RU)

(21) Appl. No.: 19/087,261

(22) Filed: Mar. 21, 2025

(30) Foreign Application Priority Data
Sep. 21, 2024 (RU) 2024127889

(51) Int. Cl. G06F 40/289; G06F 40/117; G06F 40/211; G06F 40/30

(52) U.S. Cl. CPC G06F 40/289; G06F 40/117; G06F 40/211; G06F 40/30

(57) ABSTRACT

The proposed technical solution relates to methods of automated text processing and can be used in the text corpus forming. A method for automated processing of natural language text is proposed. The technical problem solved by the claimed invention is the creation of a method and/or a computer device and/or a system and/or a machine-readable data carrier that do not have the disadvantages of analogs and thus ensure accurate automated formation of a text corpus, which can subsequently be used for pre-training, or training, or fine tuning of classification models and/or clustering models.

### FIELD OF INVENTION

The proposed invention relates to methods for automated text processing and can be used in generation of text corpora.

### DESCRIPTION OF THE RELATED ART

There are various known methods for automated natural-language text generation, such as, for example, those disclosed in patent documents US20070136321A1 dated Jun. 14, 2007, US20100205125A1 dated 08/12/20120, US20190377780A1 dated Dec. 12, 2019, US20130080883A1 dated Mar. 28, 2013, U.S. Pat. No. 10,713,443B1 dated Jul. 14, 2020, U.S. Pat. No. 10,747,953B1 dated Aug. 18, 2020, U.S. Pat. No. 11,023,662B2 dated Jun. 1, 2021, U.S. Pat. No. 11,341,323B1 dated May 24, 2022. However, the conventional solutions do not allow to generate texts in natural language with sufficient completeness that is characteristic of a certain area, such as, for example, patent documents, in which, in addition to disclosures, special parts of a patent document are also required, such as, for example, Background of the Invention, which in many cases requires a statement that discloses the technical problem or the objective of the invention (technical effect (9.2.8 Case Law of the Boards of Appeal), (technical) result (MPEP 716.02(a))).

Patent U.S. Pat. No. 11,593,564B2 dated Feb. 28, 2023 (D1) discloses systems, methods, and storage media for extracting patent document templates from a patent corpus. Exemplary implementations may: obtain a patent corpus; receive one or more parameters; determine one or more subsets of the patent corpus by filtering the patent corpus based on the one or more parameters; identify one or more document clusters within individual ones of the one or more subsets of the patent corpus; obtain a patent document template corresponding to the first document cluster; and/or perform other operations. However, the solution of D1 does not teach about any methods or ways for extracting, in particular, statements concerning objectives of inventions.

Patent U.S. Pat. No. 5,774,833A dated Jun. 30, 1998 (D2) discloses a method for processing patent text in a computer including identifying boundaries of parts of patent text, loading at least one of the parts of the patent text into a working memory, analyzing at least one of the parts of the patent text, and reporting results to a user. Alphanumeric drawing data can also be compared to patent text. The method of D2 can be coupled to work with a word processor program. The method of D2 can recognize and report on claim dependency, specific characteristics of patent text, and patent errors based on legal standards, practice standards, and Patent and Trademark Office standards, or even user preferences. However, the solution of D2 does not teach about any methods or ways for extracting, in particular, statements concerning objectives of inventions.

Therefore, there is a need in the field for a way to automatically extract statements from particular texts in natural language, such as, for example, but not limited to, patent documents.

The solution disclosed in D2 can be considered the closest prior art to the claimed invention.

### SUMMARY OF THE INVENTION

The technical problem to be solved by the claimed invention is to provide a method, and/or a computer device, and/or a system, and/or a machine-readable storage medium that do not possess the drawbacks of prior art and thus allow for precise automated generation of a text corpus that can be later used for pre-training, or training, or post-training of classification models and/or clustering models.

The objective of the proposed invention, in addition to it performing its functions, is to eliminate the drawbacks of prior art and thus allow for precise automated generation of a text corpus that can be later used for pre-training, or training, or post-training of classification models and/or clustering models. Another objective of the proposed invention is to expand the technical means, namely methods for automated natural-language text processing.

The objective of the present invention is achieved by a method for automated natural-language text processing that is executed by a processor of a computer device, the method comprising at least the following steps: identifying a natural-language text, which consists of at least three segments; identifying said segments; selecting at least a first segment and at least a second segment and/or at least a third segment of the natural-language text; marking up only one part to be analyzed in the selected first segment and marking up at least one part to be analyzed in the selected second segment and/or selected third segment; analyzing the marked up parts using semantic and syntactic analysis; extracting at least a main entity of the selected first segment from the semantically and syntactically analyzed part of the first segment and at least an associated entity that is associated with the main entity of the first segment, wherein at least one of the associated entities is an associated end entity, and extracting at least one statement from each semantically and syntactically analyzed part of the selected second segment and/or selected third segment; and associating said statement with said main entity.

### BRIEF DESCRIPTION OF THE DRAWINGS

Exemplary embodiments of the present invention are described in further detail below with references made to the attached drawings, included herein by reference:

FIG. 1 illustrates an exemplary, non-limiting, diagram for method 100 for automated natural-language text processing.

FIG. 2 illustrates an exemplary, non-limiting, diagram for system 200 for automated natural-language text processing.

### DETAILED DESCRIPTION OF THE PREFERRED EMBODIMENTS

According to a preferred embodiment of the present invention, there is provided a method for automated natural-language text processing that is executed by a processor of a computer device, the method comprising at least the following steps: identifying a natural-language text, which consists of at least three segments; identifying said segments; selecting at least a first segment and at least a second segment and/or at least a third segment of the natural-language text; marking up only one part to be analyzed in the selected first segment and marking up at least one part to be analyzed in the selected second segment and/or selected third segment; analyzing the marked up parts using semantic and syntactic analysis; extracting at least a main entity of the selected first segment from the semantically and syntactically analyzed part of the first segment and at least an associated entity that is associated with the main entity of the first segment, wherein at least one of the associated entities is an associated end entity, and extracting at least one statement from each semantically and syntactically analyzed part of the selected second segment and/or selected third segment; and associating said statement with said main entity.

According to an exemplary embodiment of the present invention, there is provided the disclosed method, characterized in that the first segment, the second segment and the third segment are preliminarily combined in order to obtain a natural-language text to be identified.

According to an exemplary embodiment of the present invention, there is provided the disclosed method, characterized in that the first segment, the second segment and the third segment are preliminarily associated with each other in order to obtain a natural-language text to be identified.

According to an exemplary embodiment of the present invention, there is provided the disclosed method, characterized in that the marked-up part to be analyzed in the selected first segment is a first sentence in a natural language.

According to an exemplary embodiment of the present invention, there is provided the disclosed method, characterized in that each extracted associated entity is semantically and syntactically analyzed, and for each associated entity, at least a main entity of the associated entity and at least a nested associated entity that is associated with the main entity of the associated entity are extracted, wherein at least one of the nested associated entities is a nested associated end entity.

According to an exemplary embodiment of the present invention, there is provided the disclosed method, characterized in that the steps of the method are repeated iteratively for all nested associated entities, including all associated entities that are nested in the associated entities, until a nested associated entity that has no further nested entities in it is extracted.

According to an exemplary embodiment of the present invention, there is provided the disclosed method, characterized in that the marked-up part of the selected first segment to be parsed is divided into a first part and a second part, and each part undergoes a semantical and syntactical analysis.

According to an exemplary embodiment of the present invention, there is provided the disclosed method, characterized in that the main entity of the selected first segment and all entities associated with it are extracted from the first part.

According to an exemplary embodiment of the present invention, there is provided the disclosed method, characterized in that a main entity of the second part and at least an associated entity that is associated with the main entity of the second part are extracted from the second part.

According to an exemplary embodiment of the present invention, there is provided the disclosed method, characterized in that each extracted associated entity is semantically and syntactically analyzed, and for each associated entity, at least a main entity of the associated entity and at least a nested associated entity that is associated with the main entity of the associated entity are extracted, wherein at least one of the nested associated entities is a nested associated end entity.

According to an exemplary embodiment of the present invention, there is provided the disclosed method, characterized in that the steps of the method are repeated iteratively for all nested associated entities, including all associated entities that are nested in the associated entities, until a nested associated entity that has no further nested entities in it is extracted.

According to an exemplary embodiment of the present invention, there is provided the disclosed method, characterized in that the main entity of the second part is associated with the main entity of the selected first segment.

According to an exemplary embodiment of the present invention, there is provided the disclosed method, characterized in that at least partial lemmatization is performed for each extracted entity.

According to an exemplary embodiment of the present invention, there is provided the disclosed method, characterized in that the markup process uses the classification model and/or the clustering model.

According to an exemplary embodiment of the present invention, there is provided the disclosed method, characterized in that the part of the first segment to be analyzed is divided using the classification model and/or the clustering model.

According to another preferred embodiment of the present invention, there is provided a method for generating a text corpus, executed by a processor of a computer device, wherein, at least using the disclosed method for automated natural-language text processing, a plurality of natural-language text pairs is obtained, each of pairs including at least one statement that is associated with a main entity of a selected first segment, and a text corpus is generated from the obtained text pairs.

According to another preferred embodiment of the present invention, there is provided a method for generating a text corpus, executed by a processor of a computer device, wherein, at least using the disclosed method for automated natural-language text processing, a plurality of natural-language text pairs is obtained, each of pairs including at least one statement that is associated with a main entity of a second part of a part of a selected first segment that is marked up for analysis, and a text corpus is generated from the obtained text pairs.

According to another preferred embodiment of the present invention, there is provided a method for pre-training, or training, or post-training a classification model, executed by a processor of a computer device, wherein a classification model is at least trained to classify a text analysis as associated with a statement obtained using any of the disclosed methods for generating a text corpus when a text analysis is inputted into the classification model, the analysis comprising at least a main entity and at least an end entity associated with the main entity, wherein the model is trained using a text corpus that has been obtained through any of the disclosed methods for generating a text corpus.

According to another preferred embodiment of the present invention, there is provided a method for pre-training, or training, or post-training a clustering model, executed by a processor of a computer device, wherein a clustering model is at least trained to classify a text analysis as associated with a statement obtained using any of the disclosed methods for generating a text corpus when a text analysis is inputted into the clustering model, the analysis comprising at least a main entity and at least an end entity associated with the main entity, wherein the model is trained using a text corpus that has been obtained through any of the disclosed methods for generating a text corpus.

According to another preferred embodiment of the present invention, there is provided a method for classifying a text analysis, executed by a processor of a computer device, wherein at least a text analysis is inputted into the disclosed classification model, the analysis comprising at least a main entity and at least an end entity associated with the main entity, and the text analysis is classified as associated with a statement obtained using any of the disclosed methods for generating a text corpus.

According to another preferred embodiment of the present invention, there is provided a method for classifying a text analysis, executed by a processor of a computer device, wherein at least a text analysis is inputted into the disclosed clustering model, the analysis comprising at least a main entity and at least an end entity associated with the main entity, and the text analysis is classified as associated with a statement obtained using any of the disclosed methods for generating a text corpus.

According to another preferred embodiment of the present invention, there is provided a database generation method, executed by a processor of a computer device, wherein a plurality of text analyses, which have been classified using any of the disclosed classification methods, is identified and associated with one or more corresponding statements, and a database is generated that includes at least the plurality of text analyses, each analysis being associated with the one or more statements.

According to another preferred embodiment of the present invention, there is provided a method for generating a database query, executed by a processor of a computer device, wherein a query to a database is generated that contains at least one statement obtained using any of the disclosed methods for generating a text corpus; wherein the database contains at least a plurality of text analyses, each analysis being associated with the at least one statement.

According to another preferred embodiment of the present invention, there is provided a method for selecting text analyses, executed by a processor of a computer device, wherein at least a query is generated and sent to a database, the query containing at least a statement obtained using any of the disclosed methods for generating a text corpus, and at least one text analysis that is associated with this statement is obtained; wherein the database contains at least a plurality of text analyses, each analysis being associated with the at least one statement.

According to another preferred embodiment of the present invention, there is provided a method for text entry generation, executed by a processor of a computer device, wherein at least one statement is obtained using any of the disclosed methods for generating a text corpus, and a syntactically and semantically correct sentence is generated that includes said statement or its derivative.

According to another preferred embodiment of the present invention, there is provided a method for generating a database of statement-containing text entries, executed by a processor of a computer device, wherein at least a plurality of text entries is obtained using the disclosed method for text entry generation and written to a database; and wherein a statement is obtained using any of the disclosed methods for generating a text corpus.

According to another preferred embodiment of the present invention, there is provided a method for natural-language text generation, executed by a processor of a computer device, wherein at least a text entry is obtained from the database generated using the disclosed method for generating a database of statement-containing text entries, and then a text in natural language is generated that includes at least said text entry and other text that is not said text entry.

According to another preferred embodiment of the present invention, there is provided a method for natural-language text generation, executed by a processor of a computer device, wherein at least a text entry in natural language, which includes at least a main entity and at least an associated end entity that is associated with it, and a statement associated with the main entity are identified, and then a text entry containing said statement is obtained from the database generated using the disclosed method for generating a database of statement-containing text entries, and a text in natural language is generated that includes at least the identified text entry and the text entry obtained from the database.

According to another preferred embodiment of the present invention, there is provided a computer device for automated natural-language text processing, comprising at least a processor; a memory that stores a program code, which, when executed by the processor, prompts the processor to perform the steps according to any disclosed methods for automated natural-language text processing.

According to another preferred embodiment of the present invention, there is provided a computer device for generating a text corpus, the device comprising at least a processor; a memory that stores a program code, which, when executed by the processor, prompts the processor to perform the steps according to any disclosed methods for generating a text corpus.

According to another preferred embodiment of the present invention, there is provided a computer device for pre-training, or training, or post-training a classification model, the device comprising at least a processor; a memory that stores a program code, which, when executed by the processor, prompts the processor to perform the steps according to any disclosed methods for pre-training, or training, or post-training of a classification model.

According to another preferred embodiment of the present invention, there is provided a computer device for pre-training, or training, or post-training a clustering model, the device comprising at least a processor; a memory that stores a program code, which, when executed by the processor, prompts the processor to perform the steps according to any disclosed methods for pre-training, or training, or post-training of a clustering model.

According to another preferred embodiment of the present invention, there is provided a computer device for classifying a text analysis, the device comprising at least a processor; a memory that stores a program code, which, when executed by the processor, prompts the processor to perform the steps according to any disclosed methods for classifying a text analysis.

According to another preferred embodiment of the present invention, there is provided a computer device for database generation, comprising at least a processor; a memory that stores a program code, which, when executed by the processor, prompts the processor to perform the steps according to any disclosed methods for database generation.

According to another preferred embodiment of the present invention, there is provided a computer device for generating a database query, the device comprising at least a processor; a memory that stores a program code, which, when executed by the processor, prompts the processor to perform the steps according to any disclosed methods for generating a database query.

According to another preferred embodiment of the present invention, there is provided a computer device for selecting text analyses, the device comprising at least a processor; a memory that stores a program code, which, when executed by the processor, prompts the processor to perform the steps according to any disclosed methods for selecting text analyses.

According to another preferred embodiment of the present invention, there is provided a computer device for text entry generation, the device comprising at least a processor; a memory that stores a program code, which, when executed by the processor, prompts the processor to perform the steps according to any disclosed methods for text entry generation.

According to another preferred embodiment of the present invention, there is provided a computer device for generating a database of statement-containing text entries, comprising at least a processor; a memory that stores a program code, which, when executed by the processor, prompts the processor to perform the steps according to any disclosed methods for generating a database of statement-containing text entries.

According to another preferred embodiment of the present invention, there is provided a computer device for natural-language text generation, comprising at least a processor; a memory that stores a program code, which, when executed by the processor, prompts the processor to perform the steps according to any disclosed methods for natural-language text generation.

According to another preferred embodiment of the present invention, there is provided a machine-readable storage medium, including a non-transitive machine-readable storage medium, that stores a program code, which, when executed by the processor, prompts the processor to perform the steps according to any of the disclosed methods.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

In the present disclosure, the term “patent document” refers to a patent or patent application, that is, usually, a particular text that consists of at least three segments: a first segment, which is patent claims; a second segment, which is a description (specification); and a third segment, which is an abstract; wherein, but not limited to, the above numbering of segments does not reflect their order in a text in natural language, but is used just for simplicity reasons in order to better understand the following disclosure, as will be shown below. Preferably, but not limited to, patent claims do not relate to new chemical compounds or other similar objects created for the first time, since, for such objects, statements about technical results are not required.

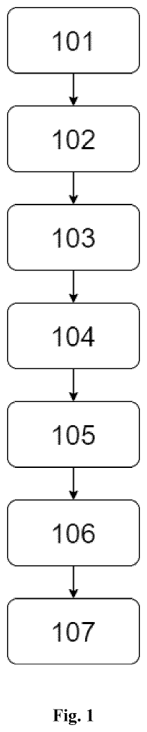

FIG. 1 illustrates an exemplary, non-limiting, diagram for method 100 for automated natural-language text processing. Method 100 comprises at least the following steps: identifying 101 a natural-language text, which consists of at least three segments; identifying 102 said segments; selecting 103 at least a first segment and at least a second segment and/or at least a third segment of the natural-language text; marking up 104 only one part to be analyzed in the selected first segment and marking up at least one part to be analyzed in the selected second segment and/or selected third segment; analyzing 105 the marked up parts using semantic and syntactic analysis; extracting 106 at least a main entity of the selected first segment from the semantically and syntactically analyzed part of the first segment and at least an associated entity that is associated with the main entity of the first segment, wherein at least one of the associated entities is an associated end entity, and extracting at least one statement from each semantically and syntactically analyzed part of the selected second segment and/or selected third segment; and associating 107 said statement with said main entity. For example, but not limited to, in step 101, a text in natural language, for example, but not limited to, a text of a patent document, is reliably identified. For example, but not limited to, segments of the text of a patent document can be represented by separate texts in natural language; therefore, if necessary, they are preliminarily associated, for example, by assigning certain signs of being interconnected to them, such as, for example, unique identifiers, which, when decoded, allow to determine whether the segments are interconnected. These methods and ways for associating entities in storage systems are widely known in the art, and therefore are not described in further detail. However, for example, but not limited to, a patent document can be a single text, which usually has a continuous page numbering. In this case, the segments do not have to be preliminarily associated with each other.

Preferably, but not limited to, in step 102, the segments of the text in natural language are identified. For example, but not limited to, in case the text in natural language is a patent document, then at least patent claims (the first segment, in the present disclosure), a description (the second segment, in the present disclosure), and an abstract (the third segment, in the present disclosure) are identified. In case, but not limited to, the text in natural language is not a patent document, its segments are identified in the same way. Furthermore, but not limited to, it should be generally noted that the first segment includes a set of entities, while the second segment and the third segment include at least one or more statements that are specific to said set of entities. An example of a suitable non-patent document can be, for example, but not limited to, a scientific article, where the first segment is the abstract, the second segment is the body of the article, and the third segment is the conclusion.

Preferably, but not limited to, in step 103, the identified segments are selected, wherein, but not limited to, the first segment is selected as the one containing the set of entities, along with one statement from the second segment or the third segment. Furthermore, but not limited to, the choice as to which statement should be selected from the second segment or the third segment depends on how likely the segment is to be present in a given segment. More specifically, but not limited to, the presence of the statement in a given segment generally depends on the requirements for the text in natural language. For example, but not limited to, when the text in natural language is a patent document, then, depending on the patent system it conforms to, the third segment (abstract) will have at least a statement about the technical results. For example, but not limited to, Russian patent documents are usually published along with an abstract containing the technical results (objectives) of the invention. Moreover, as of the filing date of the present application, the abstract of the patent to be granted is prepared by experts, who are competent in how the technical results should be formulated, which rules out any inaccuracies. At the same time, if U.S. patent documents are concerned, the abstract is usually prepared by the applicant themselves, which results in the fact that abstracts in U.S. patent documents do not have a clear-cut structure, and the presence of the statement about the technical results is not guaranteed. Therefore, for example, but not limited to, when choosing between the second segment and the third segment in a U.S. patent, it will be more effective to choose the second segment, since at least the Background of the Invention or Brief Summary of Invention section will likely have a statement about technical results as required by MPEP 608.01(c) and 608.01(d). At the same time, for example, but not limited to, for each text in natural language, a segment can be selected based on the presence of the given statement. To achieve this, for example, but not limited to, each text in natural language can be semantically and syntactically analyzed, for example, using a semantic parser, which is widely known in the art, and therefore is not described in further detail. Based on the results of the semantic and syntactic analysis, it becomes possible to determine which part of the text in natural language contains the required statement. Preferably, but not limited to, at this point, the first segment is preliminarily excluded from the text in natural language, as it obviously does not have any statements, but can distort the results of the semantic and syntactic analysis if not excluded.

Preferably, but not limited to, in step 104, the parts in selected segments are marked up. Preferably, but not limited to, only one part that is to be analyzed is marked up in the selected first segment, namely the part that contains the set of entities. For example, but not limited to, in case the text in natural language is a patent document, the part to be marked up is the first sentence, i.e. the first claim, since it most likely contains the required set of entities, i.e. a set of essential limitations. In addition, but not limited to, there are situations when the set of entities (limitations) in the first claim also includes non-essential limitations, in addition to essential ones. In this case, such a selected first segment can be analyzed again after finding the statement about the technical results in the second or third segment and checking which of the limitations do not contribute to the technical results. Based on this additional analysis, the marked-up part is cleared of unnecessary entities. Furthermore, preferably, but not limited to, the marked up and, optionally, cleaned up part of the selected first segment to be analyzed can be analyzed in order to determine whether it contains a prior art portion (the first part) and a characterising portion (the second part); wherein, for such analysis, it is sufficient, for example, but not limited to, to determine a connective word separating the prior art portion from the characterising portion. At the same time, not every patent system prescribes that independent claims must contain a characterising portion, whereby the prior art portion is not clearly defined and is not separated by a connective word. In this case, for example, but not limited to, a preliminary semantical and syntactical analysis of the whole first segment can be performed in order to identify at least the main entity of the first segment and main entities of the entities associated with the main entity of the first segment, which will be described in more detail below. As a rule, but not limited to, in case the text in natural language is a patent document, the main entity will be the subject matter, and individual limitations will be associated entities, for example, but not limited to, steps of methods or parts of products. The resulting set comprised of the main entity and associated entities can be analyzed for novelty, which will determine whether the whole set relates to prior art or only some limitations from the prior art portion. Furthermore, for example, but not limited to, the novelty analysis can be performed automatically, based on a pre-prepared corpus of texts, for each of which the first segment was determined, and the part to be analyzed was semantically and syntactically analyzed. Furthermore, but not limited to, the separation can be performed either manually or automatically, for example, using a pre-trained classification model and/or clustering model. Furthermore, but not limited to, the selected second segment or the selected third segment are marked up in such a way as to most likely obtain the required statement. Usually, the required statement is preceded by a certain text structure, or the required statement includes certain keywords. Therefore, but not limited to, several parts of the selected second segment or the selected third segment to be analyzed can be marked up. Furthermore, but not limited to, the markup can be performed either manually or automatically, for example, using a pre-trained classification model and/or clustering model. Preferably, but not limited to, in step 105, the marked-up parts are semantically and syntactically analyzed using, for example, but not limited to, the syntactic parser mentioned above.

Preferably, but not limited to, in step 106, at least a main entity of the first segment from the analyzed parts of the first segment and at least an associated entity that is associated with the main entity of the first segment are extracted, wherein at least one of the associated entities is an associated end entity. For example, but not limited to, in case the first segment is patent claims, the first independent claim will be semantically and syntactically analyzed. In this case, the main entity will be the subject matter, which is the root of the parsing tree, the associated entities will be the limitations of the technical solution, which are the nodes of the parsing tree, and at least one associated entity will be an associated end entity, i.e. it will be a limitation with only one edge, thus it will be the end node (leaf) of the parse tree. Furthermore, but not limited to, the parsing tree can be based on an Abstract Syntax Tree (AST), i.e. it can be cleared of all non-essential limitations, as well as repetitions, anaphora and other elements that do not affect the statement, i.e., in the case of a patent claim, do not contribute to the technical results. Unnecessary elements obtained after analysis include, for example, but not limited to, a comma or other separator, which are useful during analysis, serving, for example, as links or boundaries, but are unnecessary for the text corpus when it is used, for example, to train a classification model and/or a clustering model. In addition, for example, but not limited to, when the first segment was divided into the prior art portion and the characterising portion, as a result of the analysis, the main entity of the first segment will be found in the first part, i.e. the prior art portion, along with the associated entities from the prior art portion. In addition, but not limited to, the second part, which is the characterising portion, will, in this case, contain the main entity of the second part, along with the associated entities, which, nevertheless, are also all associated with the main entity of the first segment, since all the individual limitations identified through analysis directly or indirectly relate to only one subject matter. Furthermore, for example, but not limited to, each associated entity extracted in this way can be iteratively analyzed, both semantically and syntactically, whereby the corresponding main entities of the associated entities and associated entities of the associated entities will be discovered, i.e. each associated entity can have a plurality of nested associated entities up to one or more associated end entities that can no longer be semantically and syntactically analysed because they are too simple. Furthermore, for example, but not limited to, lemmatization can be performed to bring the words to their initial forms. In addition, but not limited to, for each entity, including the main entity, as well as any associated entities, a generalization operation can be performed in which the entity can be elevated to the level of a method or product that corresponds to a specific function determined by the attributes of the entity. Furthermore, preferably, but not limited to, at least one statement from each semantically and syntactically analyzed part of the selected second segment and/or selected third segment is extracted. For example, but not limited to, in case the text in natural language is a patent document, the semantic and syntactic analysis of paragraph 0010 of the present disclosure in its original version will yield two statements: “precise generation of a text corpus” and “automated generation of a text corpus”. For example, but not limited to, in the same case, the semantic and syntactic analysis of paragraph 0011 may yield three statements: “perform its function is to allow for generation of a text corpus”, “precise generation of a text corpus”and “automated generation of a text corpus”. Furthermore, preferably, but not limited to, in step 107, at least one extracted statement is associated with the main entity of the first segment, and thus the statement is associated with any associated entities that are associated with the main entity of the first segment. Furthermore, for example, but not limited to, some of the resulting statements, such as, for example, “performing its function”, are of no practical use, since they cannot be subsequently used as part of a text corpus to train a classification model and/or a clustering model, for example, in order to predict a statement corresponding to a new set of entities, because thereby any classifier based on the classification model and/or clustering model will attribute any set of entities to such statement, since such statement is inherent in all text analyses that can be obtained. Because of this, preferably, but not limited to, the resulting “statement—main entity” pairs are cleaned up, wherein unnecessary statements are removed.

Therefore, preferably, but not limited to, it becomes possible to obtain a text corpus, wherein, according to the disclosed method 100, in step 107, the said statement is associated with the main entity of the first segment (and, as a result, with all associated entities associated with the main entity) in order to obtain a plurality of pairs of texts, each of which includes at least one statement associated with the main entity of the first segment, and to generate a text corpus from the resulting pairs of texts. Alternatively, but not limited to, it becomes possible to obtain a text corpus, wherein, according to the disclosed method 100, in step 107, the said statement is associated with the main entity of the marked up second part of the first segment to be analyzed (and, as a result, with all associated entities associated with the main entity of the marked up second part of the first segment to be analyzed) in order to obtain a plurality of pairs of texts, each of which includes at least one statement associated with the main entity of the marked up second part of the first segment to be analyzed, and to generate a text corpus from the resulting pairs of texts. Such resulting text corpora, for example, but not limited to, can be used, both together and separately, for pre-training, or training, or post-training a classification model and/or a clustering model, wherein classification models and/or clustering models are at least trained to classify text analyses as associated with any of said statements, when a text analysis is inputted into a classification model and/or a clustering model, the analysis containing at least the main entity and an associated end entity associated with the main entity, and wherein training is performed on one of the disclosed text corpora, either together or separately. Thus, furthermore, but not limited to, a main entity is, for example, the main entity of the first segment or the main entity of the second part of the part of the first segment to be analyzed. To train a classification model and/or a clustering model, for example, but not limited to, a sampling from the text corpus is provided, after which the classification model and/or the clustering model is trained on it. Furthermore, for example, but not limited to, the classification model is based on one of: logistic regression, support vector machine, decision tree learning, random forest, naive Bayes classifier, k-nearest neighbors, neural network, boosting, gradient boosting, bagging, or the method of group consideration of arguments. At the same time, but not limited to, the clustering model is based on one of: k-means, Density-based spatial clustering of applications with noise (DBSCAN), hierarchical clustering, or spectral clustering. Furthermore, but not limited to, any suitable classification model and/or clustering model can be used, which is known now or will be known in the future; wherein one should consider when choosing the model that it allows to obtain the same weights for different statements. This is mainly due to the fact that several different statements may actually correspond to the same text analysis. For example, but not limited to, one and the same invention characterized by the same set of essential limitations can achieve different technical results, each of which can be suitable and solve a corresponding technical problem, due to the fact that the technical problem is mainly formulated in relation to a certain background art, or even prior art. In this regard, it is preferable that the classification model used and the clustering model used provide the fundamental possibility of classifying a text analysis as associated with several statements at once. Moreover, for example, but not limited to, the weights of statements do not necessarily have to be the same in order to make a decision on attributing the text analysis to these statements. In fact, but not limited to, attributing text analysis to several statements at once can be ensured by determining the permissible proximity of the weights of statements.

Therefore, but not limited to, after a corresponding classification model or clustering model is obtained, it becomes possible to provide a method for classifying a text analysis, wherein at least a text analysis is inputted into a classification model and/or a clustering model, the analysis comprising at least a main entity and an end entity associated with the main entity, and the text analysis is classified as associated with any statement obtained using any of the disclosed methods for generating a text corpus. Thus, furthermore, but not limited to, a main entity is, for example, the main entity of the first segment or the main entity of the second part of the part of the first segment to be analyzed.

The classified text analyses may be subsequently stored in the database of system 200 for automated natural-language text processing, which will be described in detail below with reference to FIG. 4. For this purpose, but not limited to, preferably, a database generation method is provided, executed by a processor of a computer device, wherein the plurality of classified text analyses is identified and associated with one or more corresponding statements, and a database is generated that includes at least the plurality of text analyses, each analysis being associated with the one or more statements. From the database formed in this way, it becomes possible to obtain text analyses, to which a statement selected by the user corresponds. For this purpose, preferably, but not limited to, a method for generating a database query is provided, wherein a query to a database is generated that contains at least one statement obtained using any of the disclosed methods for generating a text corpus; wherein the database contains at least a plurality of text analyses, each analysis being associated with the at least one statement. For example, but not limited to, a query may be provided containing the statement “precise generation of a text corpus”, in response to which at least one relevant text analysis will be selected. At the same time, depending on the statement, too many analyses of the text may be selected, which may make the query irrelevant. In order to increase the relevance of the query, for example, but not limited to, the query can be supplemented with an additional statement, which will inevitably reduce the resulting sample of text analyses. Therefore, preferably, but not limited to, a method for selecting text analyses is provided, wherein a query is generated and sent to a database, the query containing at least a statement obtained using any of the disclosed methods for generating a text corpus, and at least one text analysis that is associated with this statement is obtained; wherein the database contains at least a plurality of text analyses, each analysis being associated with the at least one statement.

Furthermore, but not limited to, the obtained plurality of text analyses preferably provides new possibilities for generating texts in natural language, particularly, but not limited to, such texts as patent descriptions. Preferably, but not limited to, a method for text entry generation is provided, executed by a processor of a computer device, wherein at least one statement is obtained using any of the disclosed methods for generating a text corpus, and a syntactically and semantically correct sentence is generated that includes said statement or its derivative. Furthermore, but not limited to, a text entry is a part of the text, but not the entire text, and the text, respectively, is a set of heterogeneous text entries as well. Furthermore, but not limited to, said statement may be present in the generated text entry, both unchanged and as a derivative, i.e. when the statement is modified and changed in order to ensure at least the consistency of the generated sentence. Furthermore, preferably, but not limited to, the obtained text entries can be placed in a database of statement-containing text entries. For this purpose, for example, but not limited to, a method for generating a database of statement-containing text entries is provided, wherein at least a plurality of text entries is obtained using the disclosed method for text entry generation and written to a database; and wherein a statement is obtained using any of the disclosed methods for generating a text corpus. For example, but not limited to, such a database can subsequently be used as a source of standardized entries when generating a text in natural language. For this purpose, for example, but not limited to, a method for natural-language text generation is provided, executed by a processor of a computer device, wherein at least a text entry is obtained from the database generated using the disclosed method for generating a database of statement-containing text entries, and then a text in natural language is generated that includes at least said text entry and other text that is not said text entry. More specifically, but not limited to, the text that is not said entry may be, for example, but not limited to, a text entered by the user themselves. Therefore, but not limited to, a method for natural-language text generation is provided, executed by a processor of a computer device, wherein at least a text entry in natural language, which includes at least a main entity and at least an associated end entity that is associated with it, and a statement associated with the main entity are identified, and then a text entry containing said statement is obtained from the database, and a text in natural language is generated that includes at least the identified text entry and the text entry obtained from the database. In addition, but not limited to, the identified entry is a text entry entered by the user. More specifically, but not limited to, the text entry entered by the user is a syntactically and semantically correct sentence. More specifically, but not limited to, the entry entered by the user is an independent patent claim. Therefore, for example, but not limited to, a text in natural language is generated based on the text entered by the user and including a part of the text that the user does not actually enter, i.e. which is generated automatically. In addition, but not limited to, the text itself is generated using conventional methods and means, such as, for example, NLP processors, which, accordingly, are not described in further detail.

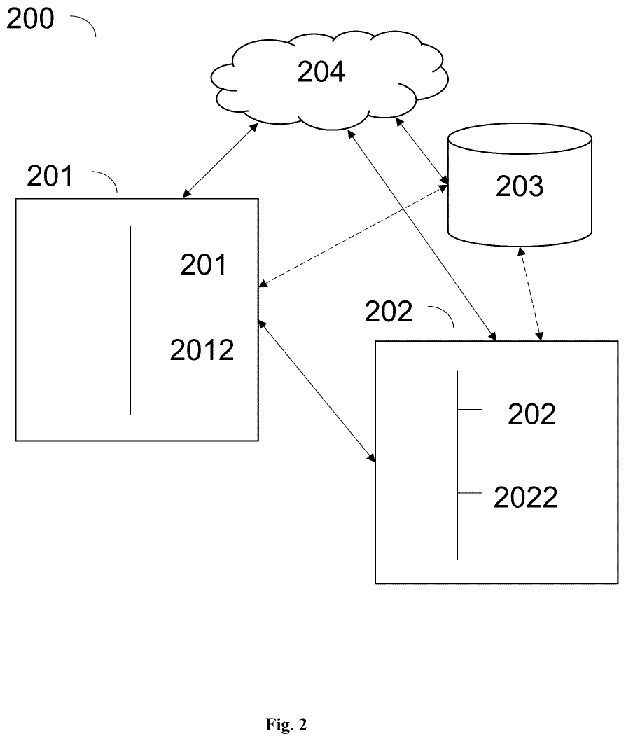

Therefore, preferably, but not limited to, as shown in FIG. 2, there may be provided a computer device 201, which may be, according to the present disclosure, at least one of a computer device for automated natural-language text processing, a computer device for generating a text corpus, a computer device for pre-training, or training, or post-training a classification model, a computer device for pre-training, or training, or post-training a clustering model, a computer device for classifying a text analysis, a computer device for database generation, a computer device for generating a database query, a computer device for selecting text analyses, or a combination thereof. Most typically, such computer device 201 comprises at least one or more processors 2011; memory 2012 that stores a program code, which, when executed by processor 2011, prompts processor 2011 to perform the steps according to any of the disclosed methods for automated natural-language text processing, and/or generating a text corpus, and/or pre-training, or training, or post-training a classification model, and/or pre-training, or training, or post-training a clustering model, and/or classifying a text analysis, and/or database generation, and/or generating a database query, and/or selecting text analyses, described with reference to FIG. 1. At the same time, such computer device can be a thin client, and thus all of the or at least the majority of computing operations will be performed on the system's server 202, which, therefore, also comprises at least processor 2021 and memory 2022, which are, therefore, essentially identical to processor 2011 and memory 2021 respectively. For example, but not limited to, the memory 2012, 2022 (computer-readable medium 2012, 2022) may comprise a non-volatile memory (NVRAM); a random-access memory (RAM); a read-only memory (ROM); an electrically erasable programmable read-only memory (EEPROM); a flash drive or other memory technologies; a CD-ROM, a digital versatile disk (DVD) or other optical/holographic media; magnetic tapes, magnetic film, a hard disk drive or any other magnetic drive; and any other medium capable of storing and encoding the necessary information. In addition, but not limited to, memory 2012, 2022 comprises a computer-readable medium based on the computer memory, either volatile or non-volatile, or a combination thereof. In addition, but not limited to, exemplary hardware devices include solid-state drives, hard disk drives, optical disk drives, etc. For instance, but not limited to, computer-readable medium 2012, 2022 (memory 2012, 2022) is not a temporary memory (i.e. a permanent, non-transitive memory), and therefore it does not contain a temporary (transitive) signal. In addition, but not limited to, memory 2012, 2022 may store an approximate environment, in which, using computer instructions or codes, including those stored in memory 2022 of server 202, the procedure of automated natural-language text processing, and/or generating a text corpus, and/or pre-training, or training, or post-training a classification model, and/or pre-training, or training, or post-training a clustering model, and/or classifying a text analysis, and/or database generation, and/or generating a database query, and/or selecting text analyses can be performed. In addition, but not limited to, computer device 201, if it is not a thin client, contains one or more processors 2011 that are designed to execute computed commands or codes that are stored in memory 2012 of device 201 in order to perform the disclosed procedures. In addition, but not limited to, server 202, essentially, can be similar to computer device 201, if it is not a thin client, and, therefore, contain one or more processors 2021 that are designed to execute computed commands or codes that are stored in memory 2022 of server 202 in order to perform the disclosed procedures. In addition, but not limited to, system 200 may further comprise database 203. Database 203 may be, but not limited to, a hierarchical database, a network database, a relational database, an object database, an object-oriented database, an object-relational database, a spatial database, a combination of two or more said databases, etc. In addition, but not limited to, database 203 at least stores classified text analyses that are associated with corresponding statements and it also can store data for analysis, classification models, clustering models and other data in memory 2021, 2022 or in any suitable memory of another computer device that is connected to computer device 201 and/or server 202, which may be, but not limited to, a memory identical to any of the memories 2021, 2022, as was shown above, and which can be accessed by server 202. In addition, but not limited to, there is provided server 202, which, in addition to the functions mentioned above, stores and facilitates the execution of computer-readable commands and codes disclosed herein, which, accordingly, won't be described again. In addition, but not limited to, server 202, in addition to the functions mentioned above, is capable of controlling the data exchange in system 200. In addition, but not limited to, data exchange within system 200 is performed with the help of one or more data exchange networks 204. In addition, but not limited to, data exchange networks 204 may include, but not limited to, one or more local area networks (LAN) and/or wide area networks (WAN), or may be represented by the Internet or Intranet, or a virtual private network (VPN), or a combination thereof, etc. In addition, but not limited to, server 202 is further capable of providing a virtual computer environment for the components of the system to interact with each other. In addition, but not limited to, network 204 provides communication between computer device 201, server 402 and, optionally, database 203. In addition, but not limited to, non-thin client computer device 201 and/or server 202 may be connected to database 203 directly, using wired or wireless communication methods, which are known in the art and therefore are not described in further detail, or, but not limited to, the database may be implemented in memory 2012, 2022. In addition, but not limited to, a suitable non-thin client computer device 201 can act as server 202 of system 200 for other computer devices 201, which are thin clients. In addition, most typically, but not limited to, components of computer device 201 and components of server 202 are interconnected, including via any kind of data bus.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A method for automated natural-language text processing that is executed by a processor of a computer device, the method comprising at least the following steps:
identifying a natural-language text, which consists of at least three segments;
identifying said segments;
selecting at least a first segment and at least a second segment and/or at least a third segment of the natural-language text;
marking up only one part to be analyzed in the first segment and marking up at least one part to be analyzed in the selected second segment and/or selected third segment;
analyzing the marked-up parts using semantic and syntactic analysis;
extracting at least a main entity of the first segment from the semantically and syntactically analyzed part of the first segment and at least an associated entity that is associated with the main entity of the first segment, wherein at least one of the associated entities is an associated end entity,
and extracting at least one statement from each semantically and syntactically analyzed part of the selected second segment and/or selected third segment;
and associating said statement with said main entity of the first segment.

2. The method according to claim 1, characterized in that the first segment, the second segment and the third segment are preliminarily combined in order to obtain a natural-language text to be identified.

3. The method according to claim 1, characterized in that the first segment, the second segment and the third segment are preliminarily associated with each other in order to obtain a natural-language text to be identified.

4. The method according to claim 1, characterized in that the marked-up part to be analyzed in the first segment is a first sentence in a natural language.

5. The method according to claim 4, characterized in that each extracted associated entity is semantically and syntactically analyzed, and for each associated entity, at least a main entity of the associated entity and at least a nested associated entity that is associated with the main entity of the associated entity are extracted, wherein at least one of the nested associated entities is a nested associated end entity; wherein the steps of the method according to claim 5 are repeated iteratively for all nested associated entities, including all associated entities that are nested in the associated entities, until a nested associated entity that has no further nested entities in it is extracted.

6. The method according to claim 1, characterized in that the marked up part of the first segment to be analyzed is divided into a first part and a second part, and each part undergoes a semantical and syntactical analysis; wherein the main entity of the first segment and all entities associated with it are extracted from the first part; and wherein a main entity of the second part and at least an associated entity that is associated with the main entity of the second part are extracted from the second part.

7. The method according to claim 6, characterized in that each extracted associated entity is semantically and syntactically analyzed, and for each associated entity, at least a main entity of the associated entity and at least a nested associated entity that is associated with the main entity of the associated entity are extracted, wherein at least one of the nested associated entities is a nested associated end entity; wherein the steps of the method according to claim 7 are repeated iteratively for all nested associated entities, including all associated entities that are nested in the associated entities, until a nested associated entity that has no further nested entities in it is extracted.

8. The method according to claim 7, characterized in that the main entity of the second part is associated with the main entity of the first segment.

9. The method according to claims 1, characterized in that at least one extracted statement is removed before a text corpus is generated.
